(19) United States
(12) Patent Application Publication
(10) Pub. No.: US 2017/0330504 A1
(43) Pub. Date: Nov. 16, 2017

(54) IMAGE PROCESSING APPARATUS AND IMAGE PROCESSING METHOD

(71) Applicant: LinkPro Co., Ltd., Tokyo (JP)

(72) Inventors: Nobukatsu HARAGUCHI, Tokyo (JP); Hideo TAMURA, Tokyo (JP); Miyuki AIZAWA, Tokyo (JP)

(73) Assignee: LinkPro Co., Ltd., Tokyo (JP)

(21) Appl. No.: 15/529,972

(22) PCT Filed: Nov. 28, 2014
(86) PCT No.: PCT/JP2014/081629

§ 371 Date: May 25, 2017

(51) Int. Cl. G09G 3/28; G06T 7/136; G06T 5/40; H04N 5/243

(52) U.S. Cl. CPC G09G 3/2803; H04N 5/243; G06T 7/136; G06T 5/40

(57) ABSTRACT

An image processing apparatus according to an embodiment includes a setting unit that sets an operator including a target pixel in a process target image, a totaling unit that acquires a gradation value of each pixel within the operator, and generates a histogram indicating the number of pixels corresponding to each gradation value from 0 to a natural number N, and a conversion unit that calculates a new gradation value by adding together the number of pixels corresponding to each of the respective gradation values ranging from gradation value 0 to the gradation value of the target pixel, or by subtracting, from gradation value N, the combined number of pixels corresponding to the respective gradation values ranging from the gradation value of the target pixel to gradation value N, and converts the gradation value of the target pixel into the new gradation value.

### TECHNICAL PROBLEM

An aspect of the present invention relates to an image processing apparatus and image processing method for converting an original image into an image that is easy to view.

### BACKGROUND ART

An image processing method of converting a screen having both extremely bright and dark portions in the same screen in an image (each frame of a still image or a moving image) captured by a surveillance camera or the like into an easy-to-view screen, as shown in Patent Literature 1, is conventionally known.

In the above image processing method, an image processing apparatus includes a capturing means that captures image data in pixel units from an image obtained by imaging a subject, and a histogram generation means that generates a histogram with luminance after the captured image data is decomposed into a specific color space, in which the image is read in a predetermined pattern for each color by the capturing means, an average histogram around a pixel at a specific position in the pattern is generated using the histogram generating means, and luminance of the pixel at the specific position is set using the average histogram.

### CITATION LIST

### Patent Literature

[Patent Literature 1] Japanese Patent No. 4386959

### SUMMARY OF INVENTION

### Solution to Problem

In the above image processing method, since a calculation process becomes complicated, the image processing method is not suitable for execution through a hardware process capable of executing a process in parallel and at a high speed, and is required to be executed through a software process. Therefore, in the software process, relatively expensive devices such as a graphics processing unit (GPU) and a memory that operates at high speed are necessary in order to realize a high-speed process. Further, when the devices are included as an image processing apparatus, a size thereof is large, and user convenience is degraded. Further, since a high operation clock is required in order to realize a high-speed software process, there is a problem in that power consumption increases. Therefore, an image processing scheme capable of appropriately converting an original image into an image that is easy to view and suitable for a hardware process is needed.

An image processing apparatus according to an aspect of the present invention includes a setting unit that sets an operator including a plurality of pixels including a target pixel in a process target image; a totaling unit that acquires a gradation value of each pixel within the operator, and generates a histogram indicating the number of pixels corresponding to each gradation value from 0 to a natural number N on the basis of the gradation value of each pixel; and a conversion unit that calculates a new gradation value by adding the numbers of pixels corresponding to the respective gradation values from gradation value 0 to the gradation value of the target pixel in the histogram or by subtracting the numbers of pixels corresponding to the respective gradation values from gradation value N to the gradation value of the target pixel from gradation value N in the histgram, and converts the gradation value of the target pixel into the new gradation value.

An image processing method according to an aspect of the present invention is an image processing method that is executed by an apparatus, the image processing method including: a setting step of setting an operator including a plurality of pixels that include a target pixel in a process target image; a totaling step of acquiring a gradation value of each pixel within the operator, and generating a histogram indicating the number of pixels corresponding to each gradation value from 0 to a natural number N on the basis of the gradation value of each pixel; and a conversion step of calculating a new gradation value by adding the numbers of pixels corresponding to the respective gradation values from gradation value 0 to the gradation value of the target pixel in the histogram or by subtracting the numbers of pixels corresponding to the respective gradation values from gradation value N to the gradation value of the target pixel from gradation value N in the histogram, and converting the gradation value of the target pixel into the new gradation value.

In this aspect, the new gradation value is calculated by the addition or the subtraction of the number of pixels corresponding to each gradation value from one end (gradation value 0 or gradation value N) of the histogram of the gradation values within the operator to the gradation value of the target pixel, and the gradation value of the target pixel is converted into the new gradation value. This process of converting the gradation value is executed for each pixel in the process target image, and therefore it is possible to obtain an image in which a portion that is difficult to view in an original process target image is made easy to view. Further, since the conversion process is realized by a combination of relatively simple calculations such as addition or subtraction, this process is suitable to be executed by hardware (a logic circuit). As described above, according to the above aspect, an image processing scheme capable of appropriately converting an original image into an image that is easy to view and suitable for a hardware process is realized.

The image processing apparatus according to another aspect may further include: a pre-processing unit that generates an entire histogram indicating the numbers of pixels corresponding to the respective gradation values from 0 to a natural number N on the basis of the gradation values of the respective pixels in an input image, converts the gradation value of each pixel in the input image on the basis of predetermined characteristics of the entire histogram, and transfers the input image after the conversion to the setting unit as the process target image; and a post-processing unit that outputs a gradation value calculated by summing the gradation value of the target pixel immediately after the conversion of the pre-processing unit and the gradation value of the target pixel immediately after the conversion of the conversion unit at a predetermined mixing ratio.

In the image processing apparatus according to yet another aspect, the pre-processing unit may determine a range of useful gradation in the entire histogram on the basis of a slope in the entire histogram, and convert the gradation value of each pixel of the input image on the basis of the range of useful gradation and a gain determined according to the range of the useful gradation.

In the image processing apparatus according to yet another aspect, the post-processing unit may determine the mixing ratio on the basis of the histogram generated by the totaling unit.

In the image processing apparatus according to yet another aspect, the number of pixels included in the operator and the number of gradation values that are able to be represented in the process target image may coincide with each other.

### Advantageous Effects of Invention

According to an aspect of the present invention, it is possible to provide an image processing apparatus and an image processing method that are suitable for a hardware process and capable of obtaining an appropriately sharpened image.

### BRIEF DESCRIPTION OF DRAWINGS

FIG. 1 is a diagram illustrating a hardware configuration of an image processing apparatus according to an embodiment of the present invention.

FIG. 2 is a block diagram illustrating a functional configuration of an image processing apparatus.

FIG. 3 is a schematic diagram illustrating an image quality adjustment process.

FIG. 4 is a diagram illustrating a circuit of a gradation value conversion unit according to a first example.

FIG. 5 is a diagram illustrating a circuit of a gradation value conversion unit according to a second example.

FIG. 6 is a flowchart illustrating an operation of the image processing apparatus.

FIG. 7 is a diagram illustrating an example of an original image and an image after sharpening.

FIG. 8 is a diagram illustrating an example of an image after sharpening, pre-processing, and post-processing.

### DESCRIPTION OF EMBODIMENTS

Hereinafter, embodiments of the present invention will now be described in detail with reference to the accompanying drawings. In the description of the drawings, the same or equivalent elements are denoted by the same reference numerals, and repeated description will be omitted.

An image processing apparatus 1 according to an embodiment of the present invention is an apparatus that captures an image such as each frame of a still image and a moving image and converts a gradation of each pixel in the captured image to generate an image that is sharpened and easy to view, and outputs the image. The image processing apparatus 1 is not limited to a specific application, and for example, the image processing apparatus 1 can obtain an image in which each frame is sharpened and easy to view by executing the above process for each frame of a video captured by a surveillance camera or the like. Here, the sharpening process is an image process that causes a portion that is difficult to view due to a deviation of the gradation in the image to be easy to view. Specifically, the sharpening process is an image process for adjusting the gradation of each pixel in the image. By sharpening the image, it is possible to obtain an image in which, for example, a portion of the image that is difficult to view due to the portion being extremely bright (or extremely dark) in an original image becomes easy to view. Here, the gradation is a numerical value expressing shading such as color or brightness in a stepwise manner. In this embodiment, an image that is a process target of the image processing apparatus 1 is assumed to include information such as resolution, a gradation value in pixel units, and gradation resolution. The gradation resolution is the number of bits that are prepared to express gradation in a stepwise manner. For example, when the gradation resolution is 8 bits, the gradation can be expressed by a gradation value of 256 steps from 0 to 255.

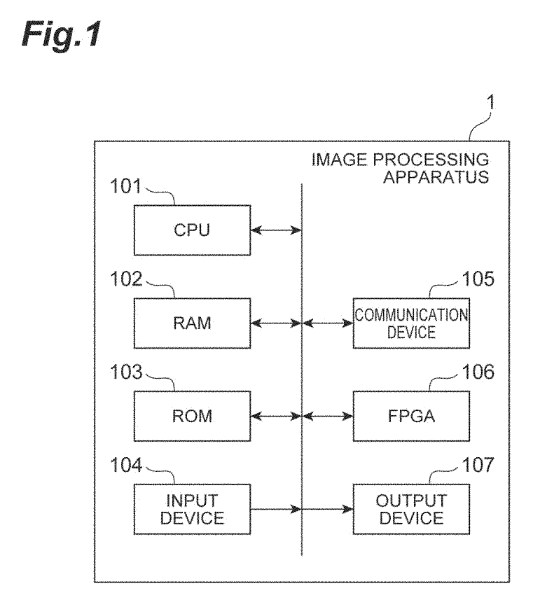

FIG. 1 is a diagram illustrating an example of a hardware configuration of the image processing apparatus 1. As illustrated in FIG. 1, the image processing apparatus 1 includes one or more central processing units (CPUs) 101, a random access memory (RAM) 102 and a read only memory (ROM) 103 that are main storage devices, an input device 104 such as a keyboard or a mouse, a communication device 105 for performing data communication with an external device such as a device such as a surveillance camera serving as an acquisition source of an input image or a database device for storing image data after sharpening, a field-programmable gate array (FPGA) 106 that is an integrated circuit for executing a gradation value conversion process to be described below, and an output device 107 such as a display.

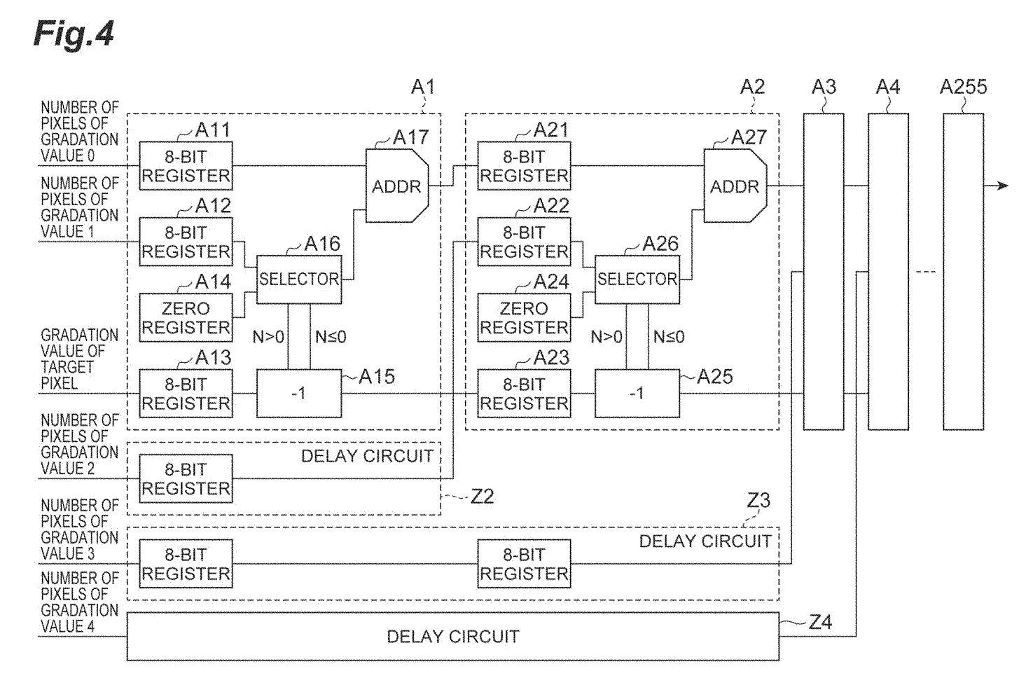

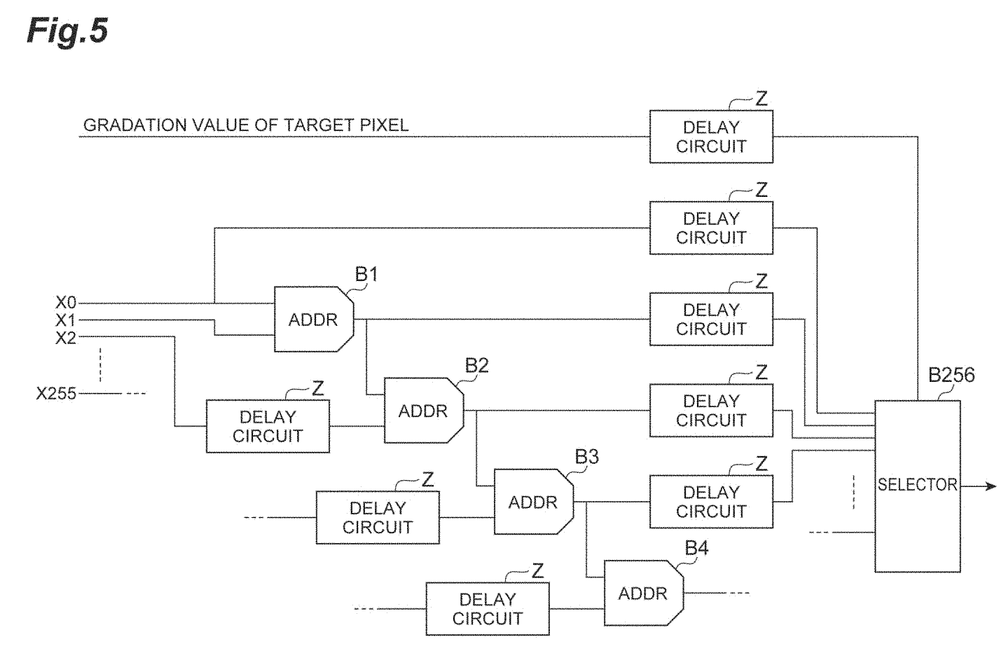

Each functional component of the image processing apparatus 1 to be described below is realized by loading predetermined computer software on hardware such as the RAM 102, operating the input device 104, the communication device 105, the FPGA 106, the output device 107, or the like under control of the CPU 101, and performing reading and writing of data in the RANI 102 and the ROM 103. A circuit for executing a gradation value conversion process to be described below (see FIGS. 4 and 5) is mounted on the FPGA 106 in advance, and the gradation value conversion process can be executed through a hardware process.

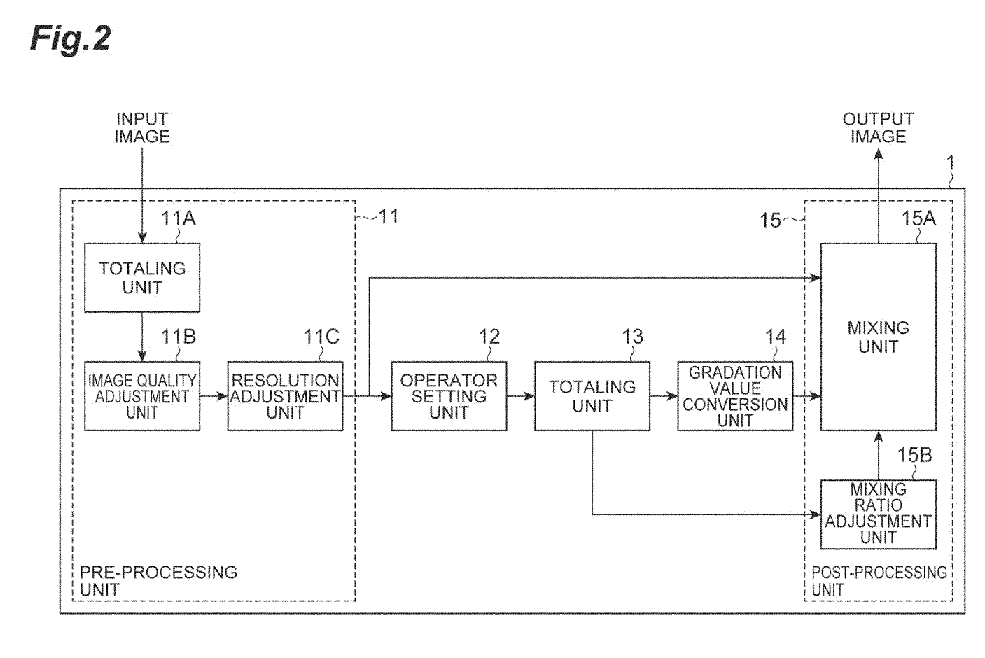

Although FIG. 2 illustrates that the image processing apparatus 1 is configured as a single computer, the functions of the image processing apparatus 1 may be distributed among a plurality of computers. Further, the image processing apparatus 1 may be configured as an appliance specializing in a function of executing image processing such as a sharpening process of an input image, or may be incorporated as a function of a computer that executes a plurality of functions.

FIG. 2 is a block diagram illustrating a functional configuration of the image processing apparatus 1. As illustrated in FIG. 2, the image processing apparatus 1 includes a pre-processing unit 11, an operator setting unit 12, a totaling unit 13, a gradation value conversion unit 14, and a post-processing unit 15. The pre-processing unit 11 includes a totaling unit 11A, an image quality adjustment unit 11B, and a resolution adjustment unit 11C. The post-processing unit 15 includes a mixing unit 15A and a mixing ratio adjustment unit 15B.

As illustrated in FIG. 2, in the image processing apparatus 1, first, the pre-processing unit 11 sequentially takes the video captured by the surveillance camera or the like and performs pre-processing on each frame of the captured video to generate a process target image. Specifically, the pre-processing unit 11 executes pre-processing on each frame of the captured video as an input image to generate a process target image. Here, the process target image is an image that is a target of the gradation value conversion process to be described below. The pre-processing in the pre-processing unit 11 is not indispensable for sharpening of the image and can be omitted. When pre-processing in the pre-processing unit 11 is omitted, the process target image coincides with the input image.

Subsequently, each pixel of the process target image output from the pre-processing unit 11 is set as the process target pixel, and the operator setting unit 12, the totaling unit 13, the gradation value conversion unit 14, and the post-processing unit 15 execute the respective processes. That is, the processes of the operator setting unit 12, the totaling unit 13, the gradation value conversion unit 14, and the post-processing unit 15 are executed for each pixel of the process target image. Through the above-described process, the gradation value of each pixel of the input image is converted and an image that includes both quality improvement and sharpening can be obtained by performing the image processing.

Subsequently, the post-processing unit 15 adjusts a degree of sharpening according to a state of the image, a preference of a user, or the like, and outputs an image after adjustment as an output image. Through the above process, an image (output image) obtained by appropriately sharpening the input image can be obtained.

Hereinafter, each functional component of the image processing apparatus 1 will be specifically described.

The pre-processing unit 11 executes pre-processing for the input image prior to the sharpening process by the gradation value conversion unit 14 to be described below. As described above, the pre-processing by the pre-processing unit 11 is not indispensable for performing image sharpening and can be omitted. However, by performing the pre-processing by the pre-processing unit 11, it is possible to achieve improvement of image quality as compared with a case in which only sharpening by the gradation value conversion unit 14 is executed. More specifically, through the pre-processing in the pre-processing unit 11, the image after the sharpening process has been executed can be a clean image with a sharp appearance.

When the pre-processing unit 11 acquires each frame of the video captured by the surveillance camera or the like as an input image, the pre-processing unit 11 converts the gradation value of each pixel of the input image on the basis of characteristics of the input image. In this embodiment, for example, the pre-processing unit 11 converts the gradation value of each pixel on the basis of a shape of a histogram regarding the gradation value of each pixel of the input image. The function of the pre-processing unit 11 is realized by the totaling unit 11A, the image quality adjustment unit 11B, and the resolution adjustment unit 11C.

The totaling unit 11A generates an entire histogram indicating the numbers of pixels corresponding to the respective gradation values from 0 to a natural number N on the basis of the gradation values of the respective pixels in the input image. Here, “natural number N” is a maximum gradation value which is determined by the gradation resolution of the input image. For example, since the gradation of each pixel is expressed by 256 steps from 0 to 255 when the gradation resolution of the input image is 8 bits, the natural number N is 255.

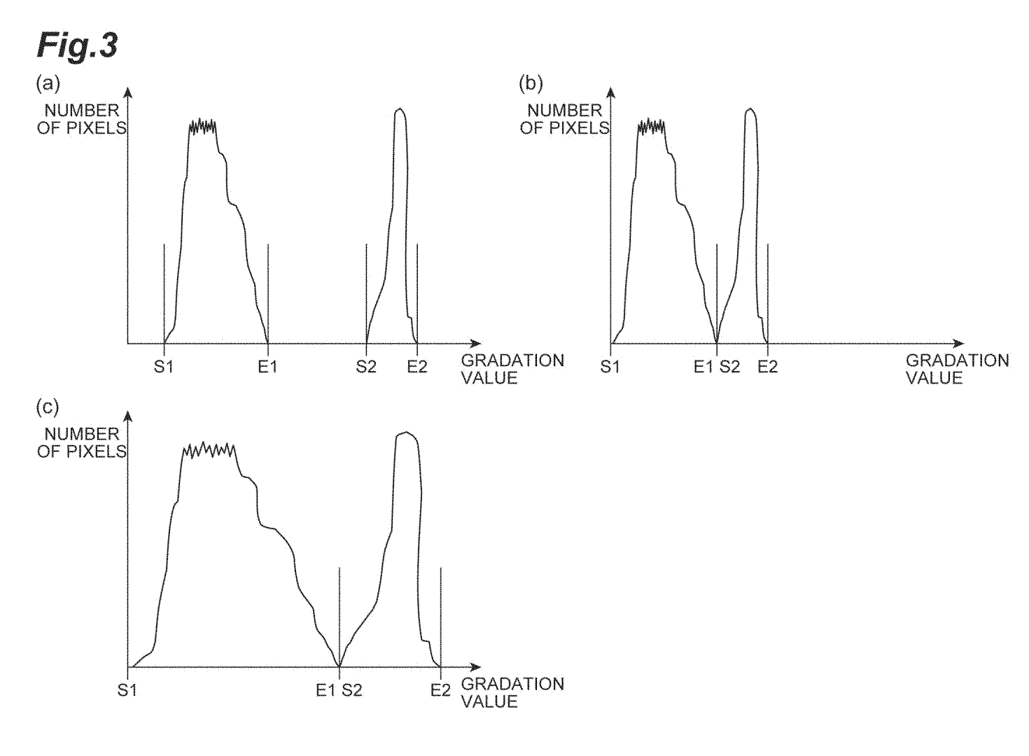

A graph (a) of FIG. 3 shows an example of the entire histogram generated by the totaling unit 11A. When the entire histogram is visualized, the histogram is a bar-like graph in which a horizontal axis is the gradation value and a vertical axis is the number of pixels, but the graph (a) of FIG. 3 is a graph obtained by expressing the entire histogram as a line graph in which adjacent vertices of the bar-like graph are connected. In this entire histogram, a mountain-like distribution is formed in each of an area in which the gradation value is from point S1 to point E1 and an area in which the gradation value is from point S2 to the point E2. An image in which the two mountains are formed in the entire histogram is often an image captured in backlight.

The image quality adjustment unit 11B converts the gradation value of each pixel in the input image on the basis of characteristics of the shape of the entire histogram generated by the totaling unit 11A. Specifically, first, the image quality adjustment unit 11B extracts an area (useful gradation area) including information useful for constituting an image in the entire histogram. Here, the information useful for constituting an image means information useful for recognizing an object reflected in an image.

For example, an area in which a level (an index indicating a multitude of the number of pixels corresponding to the gradation) is low and a slope indicated by a rate of change in the number of pixels between adjacent gradation values is small in the entire histogram can be determined to be an area (unnecessary gradation area) which has less useful information for constitution of an image. In contrast, a portion of a mountain in the entire histogram (an area from a point S1 to a point E1 and an area from a point S2 to a point E2 in the example of the graph (a) of FIG. 3) can be determined to be a useful gradation area including a large amount of information in constituting the image. On the basis of the above, for example, the image quality adjustment unit 11B can specify an area in which the level and the magnitude of the slope are equal to or smaller than respective predetermined threshold values in the entire histogram as an unnecessary gradation area, and extract other areas as useful gradation areas.

Here, in a large number of general images, an area in which the slope is small in the entire histogram is often seen in an area in which the level is low, but is rarely seen in an area (a top of a mountain or the like) in which the level is high. Using this property, the image quality adjustment unit 11B may specify an area in which the magnitude of the slope is equal to or smaller than a predetermined threshold value in the entire histogram as an unnecessary gradation area without consideration of the level, and extract the other areas as the useful gradation area.

For example, the image quality adjustment unit 11B may acquire the number of pixels corresponding to the gradation value in a direction in which the gradation value increases from gradation value 0, and may determine whether a rate of a change in the number of pixels is equal to or smaller than a threshold value between two adjacent gradation values or between two gradation values at a predetermined interval. Specifically, when the rate of the change in the number of pixels between the two gradation values is equal to or smaller than the threshold value, an area between the two gradation values may be determined to be an unnecessary gradation area, and otherwise, the area between the two gradation values may be determined to be a useful gradation area.

The image quality adjustment unit 11B can determine the point S1 illustrated in the graph (a) of FIG. 3 to be an end point of the unnecessary gradation area on a small gradation value side, that is, as a start point of the first useful gradation area, by executing such a process. Further, the image quality adjustment unit 11B can determine a point E1 illustrated in the graph (a) of FIG. 3 to be the end point of the first useful gradation area by executing the same process. Further, the image quality adjustment unit 11B can determine respective points S2 and E2 illustrated in the graph (a) of FIG. 3 to be a start point and an end point of the second useful gradation area by further executing the same process. Although the case in which there are two useful gradation areas has been described by way of example, a useful gradation area and an unnecessary gradation area can be separated using the same scheme even when there is only one useful gradation area or when there are three or more useful gradation areas.

Subsequently, the image quality adjustment unit 11B converts the gradation value of each pixel of the input image on the basis of the useful gradation area and a gain (a degree of amplification) determined according to a range of the useful gradation area. Specifically, the image quality adjustment unit 11B determines a gain so that the useful gradation area occupies the entire range of gradations that can be represented by the gradation resolution of the input image in an entire histogram after the gradation value of each pixel of the input image is converted.

In the example illustrated in the graph (a) of FIG. 3, the image quality adjustment unit 11B can determine the gain using Equation (1) and apply the gain to the gradation value of each pixel of the input image using Equations (2) and (3). In Equations (2) and (3), Vi indicates a gradation value before conversion, and Vo indicates a gradation value after conversion.

Gain=(256/((E1−S1)+(E2−S2))) (1)

If Vi<E1: Vo=(Vi−S1)×Gain (2)

If Vi>S2: Vo=(Vi−S1−(S2−E1))×Gain (3)

The calculation process illustrated in Equations (2) and (3) is executed for each pixel of the input image to delete an unnecessary gradation area as illustrated in a graph (b) of FIG. 3 and to convert a useful gradation area so that the useful gradation area occupies an entire range of gradations that can be represented by the gradation resolution of the input image, as illustrated in a graph (c) of FIG. 3. In the above process of the image quality adjustment unit 11B, a process of separating the useful gradation area and the unnecessary gradation area (in the above example, a process of determining points S1, E1, S2, and E2) may be executed through a software process, and a calculation process based on Equations (1) to (3) may be executed through a hardware process. Since it is necessary for the processes of Equations (2) and (3) to be executed for each pixel of the input image, it is possible to improve processing efficiency by executing the processes for each pixel in parallel through a hardware process.

The resolution adjustment unit 11C adjusts the gradation resolution of the input image. More specifically, the gradation resolution is adjusted so that the number of pixels included in the operator set by the operator setting unit 12 to be described below coincides with the number of gradation values that can be represented. As will be described in detail below, the operator is an area including a plurality of pixels including the target pixel within the process target image. For example, when an operator set by the operator setting unit 12 is a rectangular area including 256 pixels of 16×16, the resolution adjustment unit 11C adjusts the gradation resolution of the input image to be 8 bits capable of representing 256 step values. For example, when original gradation resolution of the input image is 10 bits, the resolution adjustment unit 11C executes a shift operation of shifting a bit pattern of the original gradation value of 10 bits to the right by 2 bits for the gradation value of each pixel of the input image. Thus, it is possible to change the gradation resolution of the input image from 10 bits to 8 bits. By adjusting the gradation resolution in this way, it is possible to simplify the calculation process in the gradation value conversion unit 14 to be described below and to improve processing efficiency.

The image processed by the pre-processing unit 11 is transferred as a process target image to the operator setting unit 12. Hereinafter, the operator setting unit 12, the totaling unit 13, and the gradation value conversion unit 14 for executing the sharpening process for the process target image will be described. As described above, the process of the operator setting unit 12, the totaling unit 13, the gradation value conversion unit 14, and the post-processing unit 15 is executed for each pixel in the process target image. Specifically, the operator setting unit 12, the totaling unit 13, the gradation value conversion unit 14, and the post-processing unit 15 scan each pixel in the process target image on a pixel-by-pixel basis, and execute the following process on the target pixel of a movement destination while sequentially moving the process target pixel (target pixel) in the process target image. This process is executed for all the pixels in the process target image to convert the gradation value of each pixel within the process target image. As a result, a sharpened image is obtained.

The operator setting unit 12 sets an operator including a plurality of pixels including the target pixel in the process target image. Here, the target pixel is a pixel that is designated as a process target pixel through the above-described scanning process, and is a pixel that is a gradation value conversion target in the gradation value conversion process. The operator is typically set as a rectangular area in which the target pixel is a center pixel. However, the operator may be anything as long as the operator is an area including the target pixel and a plurality of pixels near the target pixel, and may have, for example, a circular shape or any other shape. In this embodiment, for example, the operator setting unit 12 is assumed to set a rectangular area including 256 pixels of 16×16, in which the target pixel is a center pixel, as an operator. In a case in which the operator is set in this way, when a pixel close to a boundary of an upper side, a lower side, a left side, a right side, or the like of the process target image is set as a target pixel, an operator in which the target pixel is a center pixel cannot be set. Therefore, the operator setting unit 12 may exclude pixels near the boundary from the process target by the gradation value conversion unit 14 or may set an operator having an arbitrary shape suitable for such a pixel.

The totaling unit 13 acquires the gradation value of each pixel within the operator set by the operator setting unit 12 and generates a histogram indicating the number of pixels corresponding to each gradation value from 0 to a natural number N on the basis of the gradation value of each pixel. For example, the totaling unit 13 scans the respective pixels within the operator on a pixel-by-pixel basis in a predetermined order, and executes a counting process of increasing the number corresponding to the gradation value of the pixel of the operation target by 1. Alternatively, the totaling unit 13 may acquire the gradation values of the respective pixels within the operator in parallel and count the number corresponding to each gradation value. Accordingly, a histogram indicating the number of pixels corresponding to each gradation value is generated. The histogram here is information in which corresponding numbers of pixels X0 to X255 are associated with the respective gradation values from gradation value 0 to gradation value 255. The histogram generated by the totaling unit 13 and the gradation value of the target pixel are transferred to the gradation value conversion unit 14.

The gradation value conversion unit 14 calculates a new gradation value by adding the numbers of pixels corresponding to the respective gradation values from gradation value 0 to the gradation value of the target pixel in the histogram generated by the totaling unit 13, and converts the gradation value of the target pixel into the new gradation value. Since the original gradation value and the new gradation value of the target pixel may coincide with each other, “conversion” described herein includes not only changing the gradation value of the target pixel into a gradation value different from the original gradation value, but also updating the gradation value of the target pixel with a gradation value coinciding with the original gradation value. The gradation value conversion unit 14 executes the above-described calculation process, for example, using a logic circuit configured in the FPGA 106. Hereinafter, two circuit examples in which such a calculation process is executed will be described. Further, for example, the gradation resolution of the process target image is assumed to be adjusted to be 8 bits by the above-described resolution adjustment unit 11C. In this case, the gradation of each pixel of the process target image has a value of any one of gradation values 0 to 255.

(First Circuit Example)

FIG. 4 is a diagram illustrating a circuit of the gradation value conversion unit 14 according to a first example. The circuit illustrated in FIG. 4 is a vector adder configured to execute a first stage of the calculation process in a first addition module A1 to a 255th stage of the calculation process in a 255th addition module A255 in series, and outputs a result at every pixel clock. The pixel clock is the number of clocks required to process one pixel. Hereinafter, a specific operation of the circuit illustrated in FIG. 4 will be described.

The first addition module A1 includes registers A11 to A13, a zero register A14 in which 0 is stored, a subtractor A15, a selector A16, and an adder A17. The numbers of pixels corresponding to gradation value 0 and gradation value 1 acquired from the totaling unit 13 are stored in the registers A11 and A12, respectively, and the gradation value of the target pixel acquired from the totaling unit 13 is stored in the register A13. The subtractor A15 subtracts 1 from the gradation value of the target pixel stored in the register A13. The selector A16 compares a value N obtained through the subtraction in the subtractor A15 with 0, connects the register A12 to the adder A17 when the value N is greater than 0, and connects the zero register A14 to the adder A17 when the value N is smaller than or equal to 0. The adder A17 adds the number of pixels corresponding to gradation value 0 stored in the register A11 to the value stored in the register A12 or the zero register A14 connected by the selector A16, and transfers a calculation result to the second addition module A2.

In the calculation process of the first addition module A1, since a subtraction result of the subtractor A15 is greater than 0 when the gradation value of the target pixel is 2 or more, the register A12 is connected to the adder A11 by the selector A16, and a result of adding the number of pixels corresponding to gradation value 0 to the number of pixels corresponding to gradation value 1 is transferred to the second addition module A2. On the other hand, since the subtraction result of the subtractor A1 5 is 0 or smaller when the gradation value of the target pixel is 1 or smaller, the zero register A14 is connected to the adder A17 by the selector A16, and a result of adding the number of pixels corresponding to gradation value 0 to 0 (that is, the number of pixels corresponding to gradation value 0) is directly transferred to the second addition module A2.

The second addition module A2 includes registers A21 to A23, a zero register A24 in which 0 is stored, a subtractor A25, a selector A26, and an adder A27, similar to the first addition module A1. A calculation result of the first addition module A1 is stored in the register A21. The pixel value of gradation value 2 is stored in the register A22 in synchronization with a timing at which the calculation process in the first addition module A1 is completed, through a delay process in a delay circuit Z2. The value N obtained through the subtraction in the subtractor A15 is stored in the register A23. The subtractor A25 subtracts 1 from the value N stored in the register A23. The selector A26 compares the value N obtained through the subtraction in the subtractor A15 with 0, connects the register A22 to the adder A27 when the value N is greater than 0, and connects the zero register A24 to the adder A27 when the value N is smaller than or equal to 0. The adder A27 adds the value stored in the register A21 to the value stored in the register A22 or the zero register A24 connected by the selector A26, and transfers a calculation result to the third addition module A3.

In the calculation process of the second addition module A2, since the subtraction result of the subtractor A25 is greater than 0 when the gradation value of the target pixel is three or more, the register A22 is connected to the adder A27 by the selector A26, and a result of adding the value stored in the register A22 (a sum of the number of pixels corresponding to gradation value 0 and the number of pixels corresponding to gradation value 1) to the number of pixels corresponding to gradation value 2 (that is, a sum of the numbers of pixels corresponding to respective gradation values from gradation value 0 to gradation value 2) is transferred to the third addition module A3. On the other hand, since the subtraction result of the subtractor A25 is 0 or smaller when the gradation value of the target pixel is 2 or smaller, the zero register A24 is connected to the adder A27 by the selector A26, and a result of adding the value stored in the register A21 to 0 (that is, the value stored in the register A21) is directly transferred to the third addition module A3.

Thereafter, in the third to 255th addition modules A3 to A255, the same processes as in the first and second addition modules A1 and A2 described above are performed in series. According to this circuit, in the addition module that executes a subsequent calculation process of adding the numbers of pixels corresponding to the respective gradation values from gradation value 0 to “the gradation value of the target pixel−1,” the subtraction result of the subtractor is 0 or smaller and the zero register is connected to the adder by the selector. Therefore, the addition of the numbers of pixels is stopped. Accordingly, in the above circuit, the value finally output from the 255th addition module A255 is a result of adding the numbers of pixels corresponding to the respective gradation values from gradation value 0 to “the gradation value of the target pixel−1.”

In the determination process of the selector in each adder module, it can be arbitrarily determined whether or not 0 is included in a boundary condition. For example, in the determination process of the selector in each addition module, when the subtraction result of the subtractor is smaller than 0, the zero register may be connected to the adder, and when the subtraction result of the subtractor is equal to or greater than 0, the register in which the corresponding gradation value has been stored may be connected to the adder. In this case, the value output from the 255th addition module A255 is a result of adding the numbers of pixels corresponding to the respective gradation values from gradation value 0 to the “gradation value of the target pixel.” Since the boundary condition of the determination process of the selector in each addition module is arbitrarily set, the numbers of pixels corresponding to the respective gradation values from gradation value 0 to “the gradation value of the target pixel” or “the gradation value of the target pixel−1” are collectively simply referred to as “the numbers of pixels corresponding to the respective gradation values from gradation value 0 to the gradation value of the target pixel” herein.

Further, while the above-described circuit is configured to sequentially add the numbers of pixels corresponding to the respective gradation values from gradation value 0 to the gradation value of the target pixel, a circuit in which an initial value is set as 255 that is a maximum gradation value and which is modified to sequentially subtract the numbers of pixels corresponding to the respective gradation values from gradation value 255 to the gradation value of the target pixel may be used. That is, the gradation value conversion unit 14 may calculate a new gradation value by subtracting the number of pixels corresponding to each gradation value from gradation value 255 to the gradation value of the target pixel from the value N. With the circuit that executes such a process, the result of adding the numbers of pixels corresponding to the respective gradation values from gradation value 0 to the gradation value of the target pixel can be output, similar to the above-described circuit.

(Second Circuit Example)

FIG. 5 is a diagram illustrating a circuit of the gradation value conversion unit 14 according to a second example. The circuit illustrated in FIG. 5 includes 255 adders B1 to B255, and a selector B256. Further, a plurality of delay circuits Z are provided so that the gradation value of the target pixel and the calculation result of each of the adders B1 to B255 are output to the selector 256 at the same timing. Here, the numbers of pixels corresponding to gradation values 0 to 255 are defined as X0 to X255.

In this circuit, the gradation value of the target pixel is input to the selector B256 via the delay circuit Z. Further, the number of pixels X0 corresponding to gradation value 0 is input to the selector B256 via the delay circuit Z and is input to the adder B1. Further, the number of pixels X1 corresponding to gradation value 1 is input to the adder B1. In the adder B1, the number of pixels X0 corresponding to gradation value 0 and the number of pixels X1 corresponding to gradation value 1 are added.

An addition result of the adder B1 is input to the selector B256 via the delay circuit Z and is input to the adder B2 in the next stage. Further, the number of pixels X2 corresponding to gradation value 2 is input to the adder B2 in synchronization with a timing at which the addition result of the adder B1 is input to the adder B2 due to a delay process of the delay circuit Z. In the adder B2, the addition result (X0+X1) of the adder B1 and the number of pixels (X2) corresponding to gradation value 2 are added, and an addition result is input to the selector B256 via the delay circuit Z and is input to the adder B3 in the next stage.

Subsequently, the same processes are sequentially executed in the adders B3 to B255. According to this circuit, the gradation value N of the target pixel, the number of pixels X0 corresponding to gradation value 0, and addition results of the respective adders B1 to B255 are output to the selector B256 at the same timing. In the selector B256, a conversion table in which 256 values including “X0,” “X0+X1,” “X0+X1+X2,” . . . , “X0+X1+ . . . +X255” are stored is generated, and a value corresponding to the gradation value N of the target pixel is selected and output from the conversion table.

For example, when N is 3 (a fourth gradation value from the bottom including gradation value 0), “X0+X1+X2+X3” that is a fourth value of the conversion table is selected and output in the selector B256. Thus, according to the circuit, a result of adding the numbers of pixels corresponding to the respective gradation values from gradation value 0 to the gradation value of the target pixel is finally output by the selector B256.

For the second circuit example, a circuit modified to execute a subtracting process by a subtractor rather than the addition process of the adder may be used, similar to the first circuit example. That is, a circuit configured to have an initial value set to 255 that is a maximum gradation value, output a result of sequentially subtracting the number of pixels corresponding to each gradation value up to a gradation value of the target pixel from gradation value 255 to the selector B256, and generate the same conversion table as the above-described conversion table may be used.

The gradation value conversion unit 14 outputs the gradation value after conversion of the target pixel to the post-processing unit 15. A scheme of realizing the gradation value conversion unit 14 is not limited to the above-described circuit example, and the circuit can have an arbitrary circuit configuration as long as the circuit can obtain a result of adding the numbers of pixels corresponding to the respective gradation values from gradation value 0 to the gradation value of the target pixel, or a result of subtracting the number of pixels corresponding to each gradation value from gradation value 255 to the gradation value of the target pixel from 255, as a new gradation. Further, although the case in which the gradation value conversion unit 14 executes the gradation value conversion process through the hardware process (for example, the first and second circuit examples described above) has been described in this embodiment, the above-described gradation value conversion process may be executed through a software process. However, it is possible to eliminate various disadvantages of the software process by executing the gradation value conversion process through a hardware process.

The effects of adjustment of the gradation resolution in the resolution adjustment unit 11C that is performed so that the number of pixels included in the operator and the number of gradation values that can be represented match will be described herein. When the number of pixels included in the operator and the number of gradation values that can be represented do not match, an adjustment such as multiplying the number of pixels corresponding to each gradation value by a factor according to a ratio of the number of pixels included in the operator and the number of gradation values that can be represented is necessary. On the other hand, when the gradation resolution is adjusted so that the number of pixels included in the operator and the number of gradation values that can be represented match as in this embodiment, the adjustment as described above is not necessary. As a result, it is possible to convert the gradation value of the target pixel through a simple process based on addition and subtraction as in the circuit example described above.

The post-processing unit 15 executes post-processing for adjusting sharpening strength on the basis of the gradation value of the target pixel immediately after the conversion of the pre-processing unit 11 (hereinafter referred to as a “gradation value before sharpening”) and the gradation value of the target pixel immediately after the conversion of the gradation value conversion unit 14 (hereinafter referred to as a “gradation value after sharpening”). Specifically, the mixing unit 15A outputs a gradation value calculated by summing the gradation value of the target pixel immediately after the conversion of the pre-processing unit 11 and the gradation value of the target pixel immediately after the conversion of the gradation value conversion unit 14 at a predetermined mixing ratio, as a final gradation value of the target pixel. Here, the sharpening strength indicates a degree to which the gradation value after sharpening is emphasized when the final gradation value of the target pixel is determined by summing the gradation value before sharpening and the gradation value after sharpening at a predetermined mixing ratio. Thus, it is possible to adjust the sharpening strength by summing the gradation value before sharpening and the gradation value after sharpening at a mixing ratio according to the sharpening strength.

Specifically, the mixing unit 15A adjusts the sharpening strength, for example, in the following procedure. Here, for example, an adjustment level Li of the sharpening strength is assumed to be arbitrarily set between minimum strength “0” and maximum strength “255.” In this case, if the gradation value before sharpening of the target pixel is V1 and the gradation value after sharpening of the target pixel is V2, the mixing unit 15A can acquire a gradation value Vo after adjustment of the target pixel by executing a calculation process of Equation (4) below.

Vo=((V1/255)×(255−Li))+((V2/255)×Li) (4)

In Equation (4), when the adjustment level Li is set to minimum “0,” “Vo=V1,” and when the adjustment level Li is set to the maximum “255,” “Vo=V2.” Further, when the adjustment level Li is set to substantially intermediate “127” or “128,” “Vo∞(V1+V2)/2.” Thus, the mixing unit 15A mixes the gradation value before sharpening of the target pixel with the gradation value after sharpening of the target pixel at a ratio according to the adjustment level to output the gradation value Vo of the target pixel of which the sharpening strength has been adjusted.

Here, the adjustment level Li of the sharpening strength may be appropriately set manually by the user or may be automatically adjusted according to a distribution or the like of the gradation value within the operator. In this embodiment, for example, the mixing ratio adjustment unit 15B has a function of executing automatic adjustment of the latter, acquiring the histogram generated by the totaling unit 13, and appropriately setting the adjustment level Li on the basis of the distribution of the gradation values within the operator shown in the histogram.

For example, in a case in which the distribution of the gradation values within the operator is biased to one specific gradation value, that is, in a case in which the number of pixels corresponding to the specific gradation value coincides with the number of pixels within the operator (256 when the operator is a rectangular area of 16×16), when the sharpening process in the gradation value conversion unit 14 described above is executed, the gradation value after sharpening becomes an extreme value of 0 or 255, and an image of which the gradation value has been appropriately converted cannot be obtained. Therefore, when the distribution of the gradation values within the operator is biased to one specific gradation value, the mixing ratio adjustment unit 15B forcedly sets the adjustment level Li to 0. Accordingly, the gradation value V1 immediately after pre-processing is output by the mixing unit 15A.

Further, when the distribution of the gradation values within the operator is extremely small and is substantially flat, fluctuation (noise) may occur in the sharpened image and an image that is difficult to view is actually obtained. Therefore, the mixing ratio adjustment unit 15B may determine whether or not the distribution of gradation values within the operator is flat on the basis of a predefined criterion, and when the distribution is determined to be flat, the mixing ratio adjustment unit 15B may set the adjustment level Li smaller than a set value when the distribution is determined to be not flat. Accordingly, in a situation in which the noise may be generated due to the sharpening process, it is possible to decrease the sharpening strength and suppress the occurrence of the fluctuation.

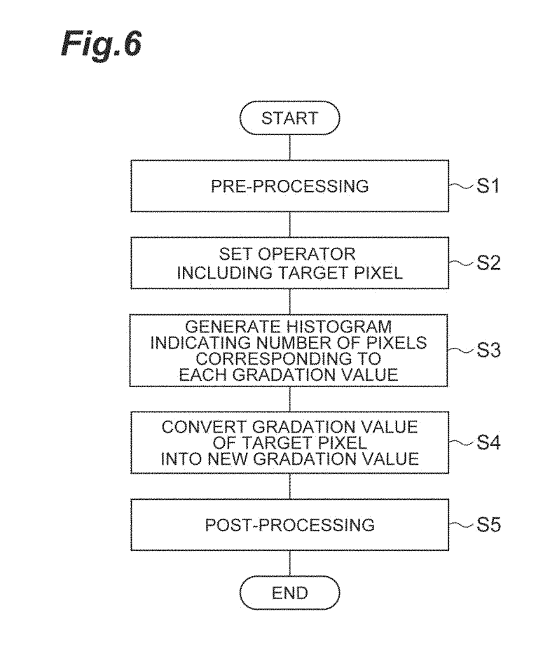

Next, an operation of the image processing apparatus 1 including an image processing method according to this embodiment will be described with reference to FIG. 6.

First, each frame of the video captured by the surveillance camera or the like is acquired as the input image by the pre-processing unit 11, and pre-processing for converting the gradation value of each pixel of the input image on the basis of the characteristics of the input image is executed (step S1). Then, processes from step S2 to step S5 are executed for each pixel of the process target image after the gradation value of each pixel is converted by the pre-processing unit 11.

Specifically, first, an operator including a plurality of pixels including the target pixel in the process target image is set by the operator setting unit 12 (step S2; setting step). Subsequently, the gradation value of each pixel within the operator is acquired by the totaling unit 13, and a histogram indicating the number of pixels corresponding to each gradation value from 0 to a natural number N is generated on the basis of the gradation value of each pixel (step S3; totaling step).

Then, in the gradation value conversion unit 14, a new gradation value is calculated by adding the numbers of pixels corresponding to the respective gradation values from gradation value 0 to the gradation value of the target pixel in the histogram generated by the totaling unit 13 or by subtracting the number of pixels corresponding to each gradation value from gradation value 255 to the gradation value of the target pixel, and the gradation value of the target pixel is converted to the new gradation value (step S4; conversion step). The process of the gradation value conversion unit 14 is realized, for example, by mounting the circuit shown in the first circuit example and the second circuit example described above on the FPGA 106.

Subsequently, in the post-processing unit 15, post-processing for adjusting the sharpening strength is executed on the basis of the gradation value of the target pixel immediately after the conversion in the pre-processing unit 11 and the gradation value of the target pixel immediately after the conversion in the gradation value conversion unit 14 (step S5). Through this post-processing, the gradation value of the target pixel of which sharpening strength has been appropriately adjusted according to preferences of the user, an illuminance distribution within the operator, or the like is output. The processes from steps S2 to S5 are executed for all the pixels in the process target image, and therefore it is possible to obtain an appropriately sharpened image.

In the image processing apparatus 1 or the image processing method described above, a new gradation value is calculated by the addition or the subtraction of the number of pixels corresponding to each gradation value from one end (gradation value 0 or gradation value N) of the histogram of the gradation values within the operator to the gradation value of the target pixel, and the gradation value of the target pixel is converted into the new gradation value. This process of converting the gradation value is executed for each pixel in the process target image, and therefore it is possible to obtain an image obtained by causing a portion that is difficult to view in an original process target image to be easy to view. Further, since the conversion process is realized by a combination of relatively simple calculations such as addition or subtraction, this process is suitable to be executed by hardware (a logic circuit). As described above, according to the above form, an image processing scheme that can appropriately convert an original image into an image that is easy to view and suitable for a hardware process is realized.

Here, when the process of converting the gradation value of the target pixel is executed through a software process, a relatively expensive device such as a graphics processing unit (GPU) and a high-speed memory is required in order to realize a high-speed process. Further, when such a device is included as an image processing apparatus, a size thereof increases, and user convenience is degraded. Further, since a high operation clock is required in order to realize a high-speed software process, there is a problem in that power consumption increases. On the other hand, with the image processing apparatus 1 or the image processing method according to this embodiment, since it is possible to convert the gradation value of the target pixel and perform sharpening through a hardware process as described above, it is possible to eliminate the disadvantage in the above-described software process.

Further, with the image processing apparatus 1 or the image processing method according to this embodiment, it is possible not only to eliminate disadvantages of the software process through a hardware process, but also to obtain results of good sharpening quality as compared with a sharpening algorithm of the related art.

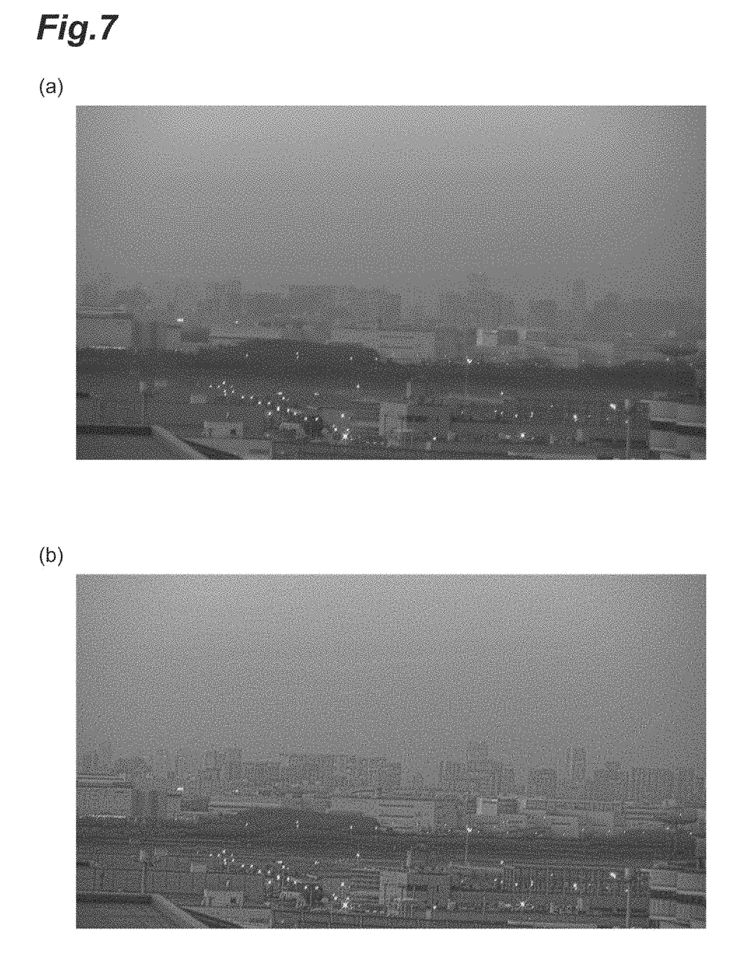

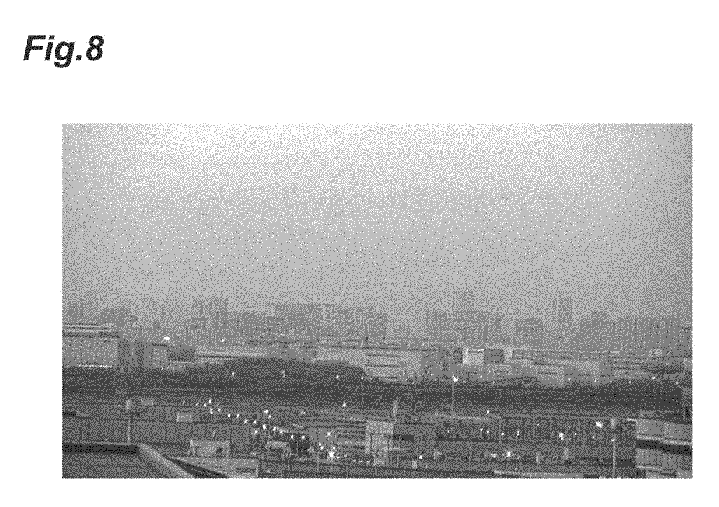

FIGS. 7 and 8 illustrate an example of an image that is obtained using the image processing method in the image processing apparatus 1 according to the embodiment. Diagram (a) of FIG. 7 illustrates an example of an original image. An original image is an unprocessed image on which any of the sharpening process, the pre-processing, and the post-processing described above is not executed. Diagram (b) of FIG. 7 illustrates an image obtained by executing only sharpening in the operator setting unit 12, the totaling unit 13, and the gradation value conversion unit 14 rather than the processes of the pre-processing unit 11 and the post-processing unit 15 on the original image illustrated in diagram (a) of FIG. 7. On the other hand, FIG. 8 is a diagram illustrating an image obtained by executing the pre-processing and the post-processing in the pre-processing unit 11 and the post-processing unit 15 in addition to the sharpening in the operator setting unit 12, the totaling unit 13, and the gradation value conversion unit 14 on the original image illustrated in diagram (a) of FIG. 7.

As illustrated in FIG. 7, an image (in diagram (b) of FIG. 7) obtained by causing a portion that is dark and difficult to view in an original image (for example, a contour of a tree in front and a contour of a building on a back side) to be easy to view can be obtained by performing the sharpening process in the operator setting unit 12, the totaling unit 13, and the gradation value conversion unit 14. Further, as illustrated in FIG. 8, the portion that is dark and difficult to view in the original image becomes easy to view, the contrast in the image becomes clearer, and an image of which an appearance is further improved can be obtained by executing the pre-processing and the post-processing and appropriately adjusting the sharpening strength.

The present invention has been described in detail with reference to the embodiments. However, the present invention is not limited to the above embodiments. The present invention can be modified in various ways without departing from the scope thereof.

### REFERENCE NUMBER LIST

1 Image processing apparatus

11 Pre-processing unit

11A Totaling unit

11B Image quality adjustment unit

11C Resolution adjustment unit

12 Operator setting unit

13 Totaling unit

14 Gradation value conversion unit

15 Post-processing unit

15A Mixing unit

15B Mixing ratio adjustment unit

101 CPU

102 RANI

103 ROM

104 Input device

105 Communication device

106 FPGA

107 Output device

1. An image processing apparatus comprising:
a setting unit that sets an operator including a number of pixels that include a target pixel in a target image;
a totaling unit that:
acquires a gradation value of each pixel within the operator, and
generates a histogram indicating a number of pixels corresponding to each gradation value ranging from 0 to a gradation value N based on the gradation value acquired from each pixel, wherein the gradation value of the target pixel is less than or equal to the gradation value N, and wherein the number of pixels included in the operator equals a maximum number N+1 of possible gradation values that are able to be represented in each pixel of the target image; and
a conversion unit that:
calculates a new gradation value of the target pixel by:
adding together the number of pixels corresponding to each of the respective gradation values ranging from gradation value 0 to the gradation value of the target pixel, or
subtracting, from the gradation value N, a combined number of pixels corresponding to the respective gradation values ranging from the gradation value of the target pixel to the gradation value N; and
converts the gradation value of the target pixel into the new gradation value.

2. The image processing apparatus according to claim 1, further comprising:
a pre-processing unit that:
generates an entire histogram indicating the number of pixels corresponding to the respective gradation values ranging from 0 to the gradation value N based on gradation values of respective pixels in an input image,
converts the gradation value of each pixel in the input image based on predetermined characteristics of the entire histogram, and
transfers the input image to the setting unit as the target image, after converting the gradation value of each pixel in the input image; and
a post-processing unit that outputs a gradation value calculated by summing the gradation value of the target pixel immediately after conversion by the pre-processing unit and the gradation value of the target pixel immediately after conversion by the conversion unit at a predetermined mixing ratio.

3. The image processing apparatus according to claim 2, wherein the pre-processing unit determines a range of useful gradation in the entire histogram based on a slope in the entire histogram, and converts the gradation value of each pixel of the input image based on the range of useful gradation and a gain determined according to the range of the useful gradation.

4. The image processing apparatus according to claim 2, wherein the post-processing unit determines the mixing ratio based on the histogram generated by the totaling unit.

5. (canceled)

6. An image processing method that is executed by an apparatus, the image processing method comprising:
setting an operator including a number of pixels that include a target pixel in a target image;
acquiring a gradation value of each pixel within the operator;
generating a histogram indicating a number of pixels corresponding to each gradation value ranging from 0 to a gradation value N based on the gradation value of each pixel, wherein the gradation value of the target pixel is less than or equal to the gradation value N, and wherein the number of pixels included in the operator equals a maximum number N+1 of possible gradation values that are able to be represented in each pixel of the target image;
calculating a new gradation value of the target pixel by:
adding together the number of pixels corresponding to each of the respective gradation values ranging from gradation value 0 to the gradation value of the target pixel, or
subtracting, from the gradation value N, a combined number of pixels corresponding to the respective gradation values ranging from the gradation value of the target pixel to the gradation value N; and
converting the gradation value of the target pixel into the new gradation value.

7. The image processing method according to claim 6, further comprising:
generating an entire histogram indicating the number of pixels corresponding to the respective gradation values ranging from 0 to the gradation value N based on gradation values of respective pixels in an input image;
converting the gradation values of the pixels in the input image based, at least in part, on a predetermined characteristic of the entire histogram; and
transferring the input image as the target image, after the gradation values of the pixels in the input image have been converted.

8. The image processing method according to claim 7, further comprising:
obtaining a first gradation value of the target pixel after the gradation values of the pixels in the input image have been converted;
obtaining a second gradation value of the target pixel after the gradation value of the target pixel has been converted into the new gradation value summing together the first gradation value of the target pixel and the second gradation value of the target pixel to obtain a combined gradation value of the target pixel; and
outputting the combined gradation value of the target pixel.

9. The image processing method according to claim 8, wherein the first gradation value of the target pixel and the second gradation value of the target pixel are summed together at a predetermined mixing ratio.

10. The image processing method according to claim 9, wherein the mixing ratio is determined based on the histogram that indicates the number of pixels corresponding to each gradation value ranging from 0 to the gradation value N.

11. The image processing method according to claim 7, further comprising:
determining a range of useful gradation based on a slope in the entire histogram; and
determining a gain according to the range of useful gradation, wherein the gradation values of the pixels in the input image are converted based on the range of useful gradation and the gain.

12. A non-transitory memory device having instructions stored thereon that, in response to execution by a processing device, cause the processing device to perform operations comprising:
setting an operator including a number of pixels that include a target pixel in a target image;
acquiring a gradation value of each pixel within the operator;
generating a histogram indicating a number of pixels corresponding to each gradation value ranging from 0 to a gradation value N based on the gradation value of each pixel, wherein the gradation value of the target pixel is less than or equal to the gradation value N, and wherein the number of pixels included in the operator equals a predetermined number of gradation values associated with the target image;
calculating a new gradation value of the target pixel by:
adding together the number of pixels corresponding to each of the respective gradation values ranging from gradation value 0 to the gradation value of the target pixel, or
subtracting, from the gradation value N, a combined number of pixels corresponding to the respective gradation values ranging from the gradation value of the target pixel to the gradation value N; and
converting the gradation value of the target pixel into the new gradation value.

13. The non-transitory memory device according to claim 12, wherein the operations further comprise:
generating an entire histogram indicating the number of pixels corresponding to the respective gradation values ranging from 0 to the gradation value N based on the gradation values of respective pixels in an input image;
converting the gradation values of the pixels in the input image based, at least in part, on a predetermined characteristic of the entire histogram; and
transferring the input image as the target image, after the gradation values of the pixels in the input image have been converted.

14. The non-transitory memory device according to claim 13, wherein the operations further comprise:
obtaining a first gradation value of the target pixel after the gradation values of the pixels in the input image have been converted;
obtaining a second gradation value of the target pixel after the gradation value of the target pixel has been converted into the new gradation value;
summing together the first gradation value of the target pixel and the second gradation value of the target pixel to obtain a combined gradation value of the target pixel; and
outputting the combined gradation value of the target pixel.

15. The non-transitory memory device according to claim 14, wherein the first gradation value of the target pixel and the second gradation value of the target pixel are summed together at a predetermined mixing ratio.

16. The non-transitory memory device according to claim 15, wherein the mixing ratio is determined based on the histogram that indicates the number of pixels corresponding to each gradation value ranging from 0 to the gradation value N.

17. The non-transitory memory device according to claim 13, wherein the operations further comprise:
determining a range of useful gradation based on a slope in the entire histogram; and
determining a gain according to the range of useful gradation, wherein the gradation values of the pixels in the input image are converted based, at least in part, on the gain.

18. The non-transitory memory device according to claim 12, wherein the predetermined number of gradation values comprises a maximum number of gradation values that are able to be represented in each pixel of the target image.

19. The non-transitory memory device according to claim 18, wherein the maximum number of gradation values comprises N+1 gradation values.
